(19) United States
(12) Patent Application Publication
(10) Pub. No.: US 2024/0124367 A1
(43) Pub. Date: Apr. 18, 2024

(54) KIND OF HIGH IMPERMEABILITY LOW THERMAL CONDUCTIVITY INORGANIC LIGHTWEIGHT FOAM CONCRETE AND PREPARATION METHOD

(71) Applicant: HENAN POLYTECHNIC UNIVERSITY, Jiaozuo (CN)

(72) Inventors: Hailin JIA, Jiaozuo (CN); Qian ZOU, Jiaozuo (CN); Yuzhong YANG, Jiaozuo (CN); Yanhe LI, Jiaozuo (CN); Jianwei LI, Jiaozuo (CN); Bo CUI, Jiaozuo, (CN); Rongkun PAN, Jiaozuo (CN)

(21) Appl. No.: 18/530,477

(22) Filed: Dec. 6, 2023

Related U.S. Application Data
(63) Continuation of application No. PCT/CN2023/095696, filed on May 23, 2023.

(30) Foreign Application Priority Data
Jul. 5, 2022 (CN) 202210782294.2

(51) Int. Cl. C04B 40/00; C04B 14/06; C04B 16/06; C04B 18/08; C04B 103/30

(52) U.S. Cl. CPC C04B 40/0046; C04B 14/062; C04B 14/068; C04B 16/0633; C04B 18/08; C04B 2103/304; C04B 2201/32

(57) ABSTRACT

The invention discloses a high impermeability and low thermal conductivity inorganic lightweight foam concrete and its preparation method, including the following mass fraction of raw materials: 1260˜1540 parts of ordinary silicate cement, 20˜60 parts of nano-silica, 460˜740 parts of fly ash, 360˜440 parts of aggregate, 9˜11 parts of redispersible latex powder, 7.2˜8.8 parts of polypropylene fiber, 27˜33 parts of quick-setting agent, 500 parts of fluorine-free foam, 900˜1100 parts of water. 33 parts, 500 parts of fluorine-free foam, 900˜1100 parts of water. The high impermeability and low thermal conductivity inorganic lightweight foam concrete prepared by the present invention has a simple formulation, good workability, light weight and low thermal conductivity, and is suitable for the construction of thermal insulation system for building exterior walls.

### CROSS-REFERENCE TO RELATED APPLICATIONS

This application is a continuation of PCT/CN2023/095696, filed May 23, 2023 and claims priority of Chinese Patent Application No. 202210782294.2, filed on Jul. 5, 2022, the entire contents of which are incorporated herein by reference.

### TECHNICAL FIELD

The present invention relates to the technical field of heat and water insulation of building facades, in particular, a kind of inorganic lightweight foam concrete with high impermeability and low thermal conductivity foam concrete and preparation method.

### BACKGROUND TECHNOLOGY

Energy consumption in buildings accounts for a large proportion of the total energy consumption of society, already more than ⅓ and will reach about 40%, which not only brings a huge burden to the energy supply, but also seriously endangers the ecological environment, so it is urgent to promote energy conservation in buildings. In this context, improving the thermal insulation performance of the building envelope helps to reduce the heat loss caused by the difference between indoor and outdoor temperature, which is conducive to the stability of the room environment. Foam concrete, as a new type of thermal insulation and heat preservation material for exterior walls, contains a large number of closed pores inside, and the air trapped in the closed pores is an excellent heat insulation medium, which can effectively stop heat transfer and is used in exterior wall insulation system. With the improvement of building energy-saving demands, the requirements for foam concrete thermal insulation performance in the construction field are also gradually upgraded, and low density, low thermal conductivity, high impermeability, etc. become the main indicators of optimization. In the face of this new requirement, the conventional admixtures have become incompetent, and it is urgent to seek other high-performance admixtures and dopants.

In the 1990s, scholars gradually perceived the excellent properties of nanomaterials and began to study the application of nanomaterials in concrete. Among them, nano-SiO₂ is an inorganic chemical material in the ultra-fine nanoscale with a size of about 20 nm, which has many excellent properties and is an important raw material to enhance the performance of concrete. he et al. found that the incorporation of nano-SiO₂ can increase the compactness and compressive strength of the hydration products of concrete pore walls. abhilash et al. added nano-SiO₂ with a dosing of 3% to concrete to improve the compressive strength and durability of concrete. She et al. pointed out that nano-SiO₂ can increase the compactness of concrete structure and improve the compressive strength of concrete. By incorporating nano-SiO₂ into concrete, Hu et al. found that it could improve its 3 d and 28 d compressive strength.

To summarize the above review of literature, it is found that previous studies on nano-SiO₂ have mostly focused on improving the compressive strength, frost resistance and durability of concrete. However, not many studies have been conducted on the systematic use of nano-SiO₂ to improve the impermeability, thermal insulation and fine structure of foam concrete, especially in terms of enhancing the impermeability mechanism. Based on this, the experimental compounding of foam concrete with different doses of nano-SiO₂ was designed based on the single variable method to study the influence of nano-SiO₂ on the macroscopic properties and microscopic morphology of foam concrete, especially on the analysis of the enhancement efficiency of impermeability, and to reveal the enhancement mechanism of impermeability in combination with SEM analysis, in order to obtain a kind of inorganic lightweight foam concrete with high impermeability and low thermal conductivity.

By searching relevant patents, it was found that some inventors have carried out research work on the compressive strength and density of foam concrete under different compounding schemes. For example, the Chinese patent with authorized publication number CN108585941A proposes a high-strength foam concrete formulation, but it cannot be more lightly applied to building facades due to its higher density. Another example is the Chinese patent No. CN114057449A, which proposes a lightweight foam concrete formulation, but its main purpose is to adsorb formaldehyde and polluting organic matter, etc. It does not make relevant determination of compressive performance and thermal conductivity. The Chinese patent with the public number CN113511873A provides a preparation method of high-strength lightweight foam concrete, pointing out that when the porosity is reduced, it can improve its strength resistance and seepage resistance, but there is no data to confirm its excellent seepage resistance. Foam concrete as a new type of building exterior thermal insulation material, in addition to dry density and compressive strength to meet the requirements, its impermeability performance and thermal insulation performance is crucial in thermal insulation and heat preservation. If the seepage resistance is low, it will largely affect the water absorption and durability of building exterior wall insulation board; higher water absorption will lead to its thermal conductivity increasing, and the heat insulation effect will drop sharply, which is not conducive to the energy saving and emission reduction of building houses.

### CONTENT OF THE INVENTION

In order to overcome the above deficiencies, the present invention provides a high impermeability and low thermal conductivity inorganic lightweight foam concrete, which is applied to the thermal insulation and heat preservation of building envelope; the purpose is to enhance the foam concrete to resist the infiltration of external moisture and harmful ions, improve its impermeability, and more importantly, further reduce the thermal conductivity and optimally enhance the thermal insulation and heat preservation performance. At the same time, the existing foam compounding scheme mostly contains PFOS components, especially after the introduction of the international environmental convention “Stockholm Convention on Persistent Organic Pollutants”, fluorocarbon foam needs to gradually withdraw from the stage of this reality, in order to practice the concept of green, low-carbon development, the foam compounding scheme in the patent of the invention avoids fluorocarbon surfactants, and chooses silicone surfactants, hydrocarbon surfactants, nano-silica, ammonium polyphosphate and ammonium phosphate, Nano-silica, ammonium polyphosphate and urea are chosen as the fluorine-free foam compounding scheme.

To achieve the above purpose, the present invention is implemented in accordance with the following technical solution:
A high impermeability low thermal conductivity inorganic lightweight foam concrete, including the following mass fraction of raw materials: 1260˜1540 parts of ordinary silicate cement, 20˜60 parts of nano-silica, 460˜740 parts of fly ash, 360˜440 parts of aggregate, 9˜11 parts of redispersible latex powder, 7.2˜8.8 parts of polypropylene fiber, 27˜33 parts of quick-setting agent, 500 parts of fluorine-free foam 900˜1100 parts of water;
Further, said fluorine-free foam is compounded by silicon surfactant, hydrocarbon surfactant, nano-silica, ammonium polyphosphate, urea and water, said silicon surfactant, hydrocarbon surfactant, nano-silica, ammonium polyphosphate and urea ratios are 0.06%-0.1%, 0.06%-0.1%, 0.06%-0.1%, 0.1%-0.2%, 0.3%-0.4%, and the remaining is water, 0.3%-0.4%, and the remaining is water; on the one hand, the compounded fluorine-free foam of this application eliminates the bioaccumulation effect of the existing fluorocarbon foam and the damaging effect on the environment; on the other hand, the fluorine-free foam has strong stability and liquid-holding capacity, which is conducive to the foaming of foam concrete;
Further, the average particle size of said nano-SiO₂ is 20-30 nm, and the SiO₂ content is 99.99%; with high active volcanic ash effect, crystalline nucleation effect and morphological effect, etc., which can not only react with the alkaline material Ca(OH)₂ in cement, but also react with the hydration product C₃S in a secondary hydration reaction to generate a kind of continuous C—S—H cementitious material that can be used to increase the internal compactness of foam concrete These chain-like bodies are interwoven into a net-like structure, which can form a water-resistant barrier layer inside the foam concrete and effectively prevent the infiltration of external moisture and harmful ions. The highly active nano-silica particles can be adsorbed on the air-liquid interface of the bubble by sufficient mixing and interspersed between the surface active ion groups in the liquid film, changing the arrangement structure of the adsorbed molecules on the surface of the bubble, effectively reducing its surface energy and surface tension, forming a more dense mixed film structure, effectively improving the adhesion of the air/liquid interface, preventing the loss of liquid inside the bubble, thus effectively slowing down the precipitation process of the bubble, increasing the foam stability of the bubble and reduce the rate of bubble breakage;
further, said aggregate is Zhengzhou origin river sand with a fineness modulus of 2.4-2.8 and a particle size of 0.4-0.5 mm;
Further, that said redispersible latex powder has a pH value of 7, an average particle size of 70-80 μm, and a solid content of 98%;
Further, that said polypropylene fiber has a phase volume diameter of 0.04-0.05 mm, a length of 10-12 mm, and an apparent density of 0.90 g/cm³;

A method for preparing high impermeability low thermal conductivity inorganic lightweight foam concrete, comprising the following steps:
In the first step, ordinary silicate cement weighed by an electronic balance is poured into a mixing barrel and nano-silica particles are mixed into the silicate cement, and dry mixing is carried out using a mixer so that the silicate cement and the nano-silica particles are fully mixed in advance;
In the second step, the weighed fly ash, aggregate, polypropylene fiber, re-dispersible latex powder and quick-setting agent are added to the fully mixed silicate cement and nano-silica in the first step in turn, while the fluorine-free foam stock solution is mixed with an appropriate amount of water, and the fluorine-free foam required for the experiment is prepared by air compressor drive;
In the third step, the weighed water is added to the mixing bucket after mixing in the second step, and the mixer is used to mix thoroughly to obtain a cement-based slurry with reasonable fluidity and homogeneity;
In the fourth step, the foam prepared in the second step is mixed into the cement slurry mixed in the third step, and the mixer is used to mix thoroughly so that the foam is fully and uniformly dispersed in the cement slurry;
In the fifth step, the cement-based slurry mixed well in the fourth step is poured into the triplex steel test mold and pre-cured for 1-2 d and demolded after curing for 28 d to obtain foam concrete with high impermeability and low thermal conductivity.

Compared with the prior art, the high impermeability and low thermal conductivity inorganic lightweight foam concrete of the present invention and its preparation method have the following beneficial effects:
The fluorine-free foam prepared by the present invention has adjustable foaming multiplier and 25% long precipitation time. Highly active nano-silica particles can be adsorbed and gathered on the gas-liquid interface of the bubble, interspersed between the surface active ion groups in the liquid film, changing the arrangement structure of the adsorbed molecules on the surface of the bubble, effectively reducing its surface energy and surface tension, forming a more dense mixed film structure, effectively improving the adhesion of the gas/liquid interface, preventing the loss of liquid in the bubble, making the foam less likely to rupture under the dual action of cement slurry weight extrusion and surface tension. It can make the foam not easy to rupture under the double action of cement slurry weight extrusion and surface tension liquid discharge, which is conducive to the formation of interconnected closed pores inside the foam concrete and helps to improve its pore structure.

The present invention mixes nano-silica as a highly active modifier into cement-based slurry, its particle size is tiny, nano-scale, only 20-30 nm, which can effectively fill in the tiny cavities and cracks in the cement slurry, and react with the alkaline material Ca(OH)₂ in the cement slurry to form C—S—H cementitious material, which can be used to strengthen its structural compactness, and the nano-silica particles have super high surface energy, can be adsorbed on the inner wall of bubble pores of foam concrete, easy to react with other raw material particles and unsaturated bonds to form a more stable structure, and the surface of nano-silica contains more different bonding state hydroxyl (—OH) and unsaturated residual bonds, they can combine and react with each other, and closely arranged on the surface of cement-based slurry, forming a layer of water-resistant barrier, which can effectively prevent external moisture It can effectively prevent the infiltration of external moisture and harmful ions, and improve the impermeability and durability of foam concrete.

The formulation of the present invention for preparing high impermeability and low thermal conductivity foam concrete is simple, has good workability, is lightweight and has low thermal conductivity, and is suitable for the construction of thermal insulation systems for building facades.

### DESCRIPTION OF THE ACCOMPANYING DRAWINGS

In order to more clearly illustrate the technical solutions in the embodiments or prior art of the present invention, the following is a brief description of the accompanying drawings to be used in the description of the embodiments or prior art, and it is obvious that the accompanying drawings in the following description are only some embodiments of the present invention, and other accompanying drawings can be obtained according to them without any creative labor for those of ordinary skill in the art.

FIG. 1 is a schematic diagram of the bubble-stabilizing action of the nanosilica of the present invention;

FIG. 2 is a scanning electron microscope proof diagram of the water resistant barrier layer of the present invention;

FIG. 3 is a diagram of the formation mechanism of the water resistant barrier layer of the silica nanoparticles of the present invention;

FIG. 4 is a flow diagram of the fabrication of the cement paste of the present invention;

FIG. 5 is a flow diagram of the introduction of the fluorine-free foam of the present invention;

FIG. 6 is a comparison diagram of the depth of water penetration of foam concrete of embodiments 1-3 of the present invention;

FIG. 7 is a comparison diagram of the moisture surface penetration of foam concrete of the baseline group and Example 3 of the present invention.

### SPECIFIC EMBODIMENTS

The present invention is further described hereinafter in connection with the accompanying drawings and specific embodiments, wherein the schematic embodiments of the invention and the description are used to explain the invention, but are not intended to be a limitation of the invention.

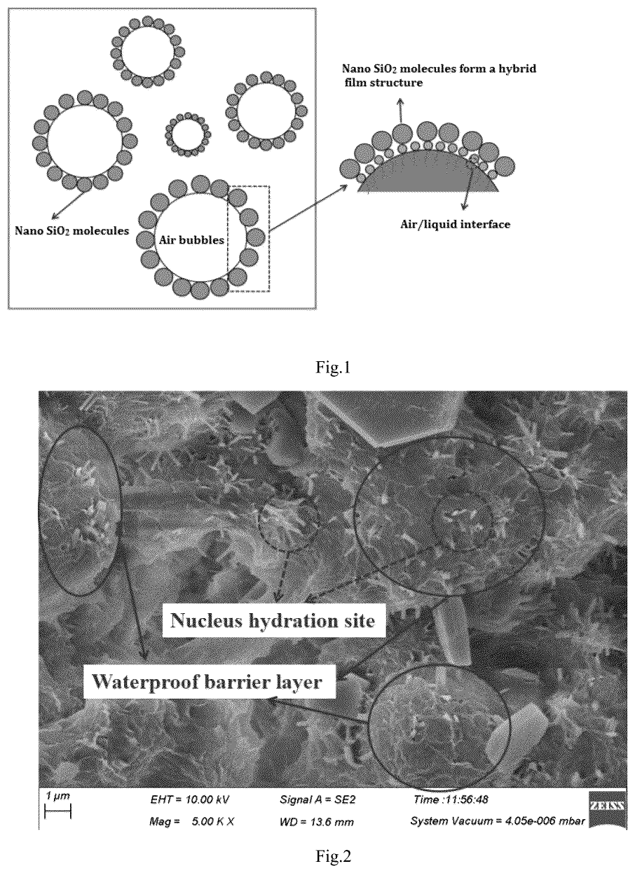

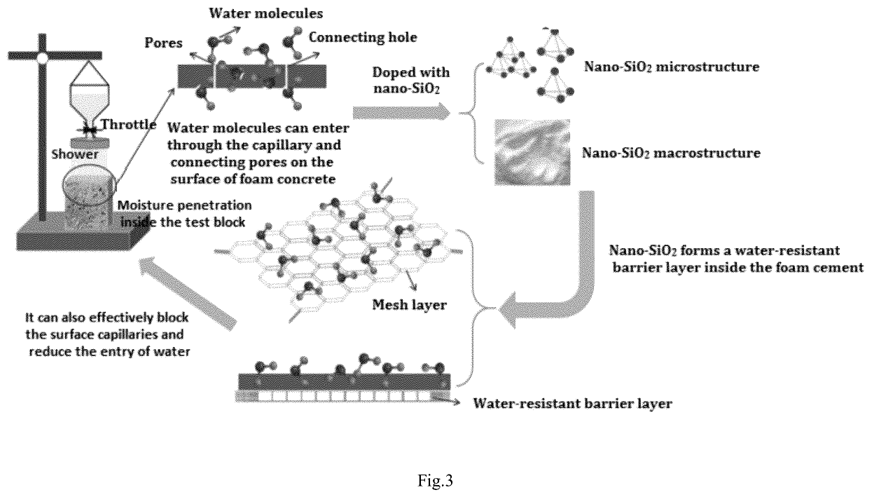

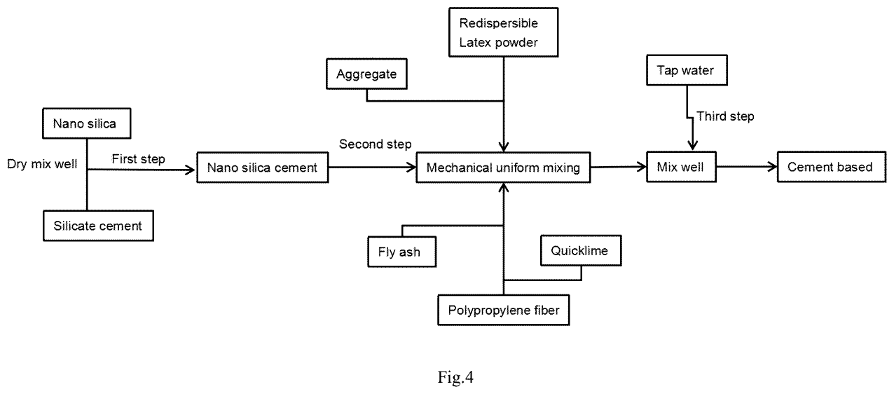

Example 1: A high impermeability low thermal conductivity inorganic lightweight foam concrete, prepared as follows:
In the first step, first weigh 1260 g of ordinary silicate cement by mass using an electronic balance and pour it into a mixing bucket; then weigh 20 g of nano-silica, mix it into the silicate cement, and dry pre-mix it for 1 min using a mixer to make the nano-silica particles and cement fully mixed, which helps the nano-silica particles adsorb on the surface of cement particles and better play its volcanic ash effect, Nano silica as a stabilizer, the highly active nano silica particles can be adsorbed and gathered on the gas-liquid interface of the bubble by sufficient mixing, and interspersed between the surface active ion groups in the liquid film, changing the arrangement structure of the adsorbed molecules on the surface of the bubble, effectively reducing its surface energy and surface tension, forming a more dense mixed film structure, and effectively improving the adhesion of the gas/liquid interface. Effectively improve the adhesion of gas/liquid interface, prevent the loss of liquid inside the bubble, and then effectively slow down the precipitation process of the bubble, increase the stability of the foam and reduce the breakage rate of the bubble, the stabilizing effect of nano-silica is shown in FIG. 1; the large amount of SiO₂ contained inside cannot only react with the alkaline Ca(OH)₂ in cement, but also with the hydration product C₃S to produce a secondary hydration reaction These chains are interwoven into a net-like structure, which can form a water-resistant barrier layer inside the foam concrete, as shown in the microscopic morphology in FIG. 2, and FIG. 3 shows the formation mechanism of the water-resistant barrier layer of silica nanoparticles, and the crystalline nucleation effect can also form more crystalline nucleation hydration sites on the surface of the cement-based paste to promote the early hydration. The formation of water-resistant barrier layer largely prevents the infiltration of external water and harmful ions, and nano-SiO₂ as a modifier is pre-mixed with ordinary silicate cement to make nano-SiO₂ particles evenly adsorbed on the surface of cement particles;
In the second step, 740 g of weighed fly ash, 360 g of aggregate, 7.2 g of polypropylene fiber, 9 g of re-dispersible latex powder and 27 g of quick-setting agent are poured into the mixing bucket in the first step in turn, and then 500 g of fluorine-free foam is prepared by air compressor and foaming machine to be set aside;
In the third step, pour the weighed water 900 g into the mixing bucket in the second step, and use the mixer to mix evenly for 2 min to get a cement slurry with reasonable fluidity and uniformity, then mix the foam prepared in the second step into the cement slurry and mix fully for 2 min, and finally get a uniform and reasonable cement-based slurry, FIG. 4 shows the flow chart of cement slurry production; then pour it into the triplex steel test mold (the surface is evenly coated with machine oil), and pre-condition it for 1˜2 d, and demold it after 28 d of curing to prepare 1# high impermeability and low thermal conductivity foam concrete.

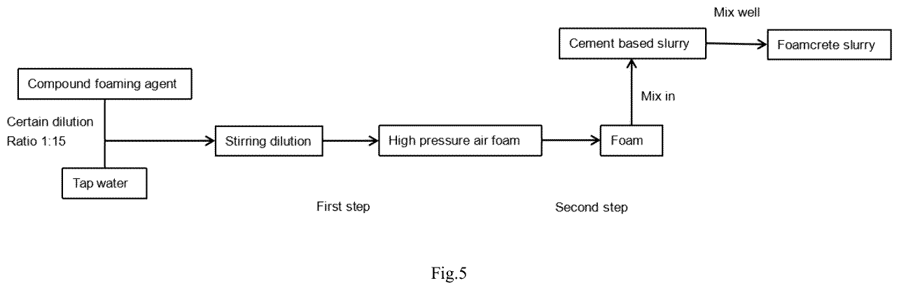

Among them, 500 g of fluorine-free foam is compounded by 0.5 g of silicone surfactant LS-99, 0.5 g of anionic sodium dodecyl sulfate SDS, 0.5 g of nano-silica, 0.75 g of ammonium polyphosphate APP and 1.5 g of urea with appropriate amount of water. The foam made by fluorine-free foam has high stability, high film toughness and high mechanical strength, not easy to break or over deformation under the weight of cement slurry, which is conducive to the formation of interconnected closed holes inside the foam concrete, and the bubble diameter of the foam is between 0.1˜1 mm with uniform pore size; FIG. 5 shows the flow chart of fluorine-free foam. FIG. 5: Flow chart of the introduction of fluorine-free foam.

Example 2: A high impermeability low thermal conductivity inorganic lightweight foam concrete, prepared as follows:
In the first step, first weigh 1400 g of ordinary silicate cement by mass using an electronic balance and pour it into a mixing bucket; then weigh 30 g of nano-silica, mix it into the silicate cement, and dry pre-mix it for 1 min using a mixer to fully mix the nano-silica particles and the cement;
In the second step, 600 g of fly ash, 400 g of aggregate, 8 g of polypropylene fiber, 10 g of re-dispersible latex powder and 30 g of quick-setting agent were weighed and poured into the mixing bucket in the first step in turn; then 500 g of fluorine-free foam was prepared by air compressor and foaming machine and set aside;
In the third step, 1000 g of weighed water is poured into the mixing barrel of the second step, and the mixer is used to mix evenly for 62 min to get a cement slurry with reasonable fluidity and uniformity; subsequently, the foam prepared in the second step is introduced into the cement slurry and mixed fully for 2 min, and finally a uniform and reasonable cement-based slurry is obtained. The foam concrete with 2# high impermeability and low thermal conductivity was prepared by pouring it into a triplex steel test mold (the surface was evenly coated with machine oil) and pre-curing for 1˜2 d and demolding after curing for 28 d.

Among them, 500 g of fluorine-free foam is compounded by 0.5 g of silicone surfactant LS-99, 0.5 g of anionic sodium dodecyl sulfate SDS, 0.5 g of nano-silica, 0.75 g of ammonium polyphosphate APP and 1.5 g of urea with appropriate amount of water. After being mixed and balanced by stirring bar, the fluorine-free foam liquid is foamed through the foaming machine by using air compressor.

Example 3: A high impermeability low thermal conductivity inorganic lightweight foam concrete, prepared as follows:
In the first step, first weighing 1540 g of ordinary silicate cement by mass using an electronic balance and pouring it into a mixing bucket; then weighing 50 g of nano-silica, mixing it into the silicate cement, and dry pre-mixing for 1 min using a mixer to fully mix the nano-silica particles and the cement;
In the second step, 460 g of fly ash, 440 g of aggregate, 11 g of re-dispersible latex powder, 8.8 g of polypropylene fiber and 33 g of quick-setting agent were poured into the mixing bucket in the first step in turn; then 500 g of fluorine-free foam was prepared by air compressor and foaming machine to be set aside;
In the third step, 1100 g of weighed water is poured into the mixing barrel of the second step, and the mixer is used to mix evenly for 2 min to get a cement slurry with reasonable fluidity and uniformity; subsequently, the foam prepared in the second step is mixed into the cement slurry and mixed fully for 2 min to finally get a uniform and reasonable cement-based slurry. Then it was poured into the triplex steel test mold (the surface was evenly coated with machine oil) and pre-cured for 1˜2 d and demolded after curing for 28 d to prepare 3# high impermeability and low thermal conductivity foam concrete.

Among them, 500 g of fluorine-free foam is compounded by 0.5 g of silicone surfactant LS-99, 0.5 g of anionic sodium dodecyl sulfate SDS, 0.5 g of nano-silica, 0.75 g of ammonium polyphosphate APP and 1.5 g of urea with appropriate amount of water. After being mixed and balanced by stirring bar, the fluorine-free foam liquid is foamed through the foaming machine by using air compressor.

Benchmark group: foam concrete is prepared as follows:
In the first step, 1260 g of ordinary silicate cement is weighed by mass using an electronic balance and poured into a mixing drum, followed by 600 g of fly ash, 360 g of aggregate, 8 g of polypropylene fiber, log of re-dispersible latex powder and 30 g of quick-setting agent; then 500 g of fluorine-free foam is prepared by an air compressor and a foaming machine and set aside;
In the second step, 900 g of weighed water was poured into the mixing bucket in the first step, and the mixer was used for uniform mixing for 2 min to obtain a cement slurry with reasonable fluidity and homogeneity, followed by mixing the foam prepared in the first step into the cement slurry and mixing it fully for 2 min to finally obtain a uniform and reasonable cement-based slurry. Then it was poured into the triplex steel test mold (the surface was evenly coated with machine oil) and pre-cured for 1˜2 d and demolded after curing for 28 d to prepare the benchmark group foam concrete.

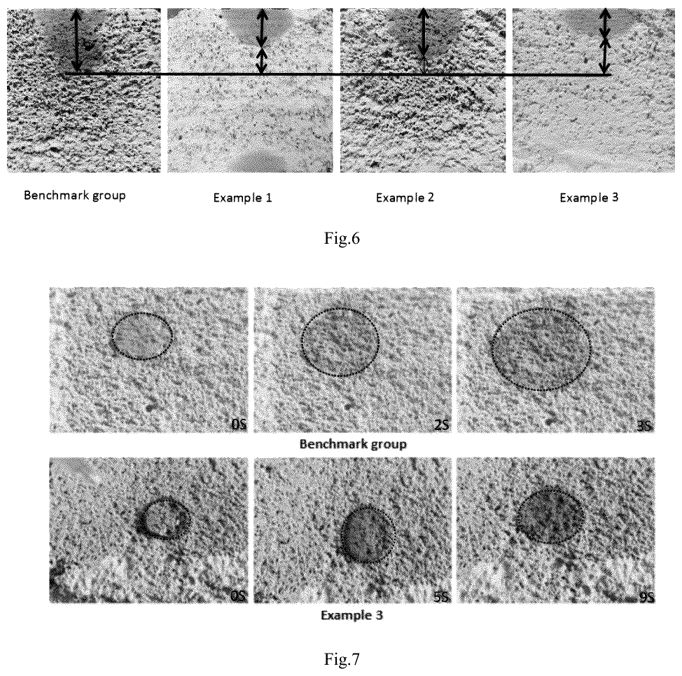

The 1#, 2# and 3# foam concrete specimens prepared from the benchmark group and Examples 1˜3 were tested for dry density and thermal conductivity in accordance with JG/T 266-2011 standard specification for foam concrete and the “Determination of steady-state thermal resistance and related properties of insulation materials protective thermal plate method” GB10294-2008. FIG. 6 shows the comparison of the moisture penetration depth of foam concrete of Example 13 and the benchmark group; FIG. 7 shows the comparison of the moisture surface penetration of foam concrete of the benchmark group and Example 3.

At present, there is no clear and unified standard specification for the test method of the permeability resistance of lightweight foam concrete in China, this experiment is designed by itself to determine the permeability resistance of foam concrete, the test method is to use a syringe to drop 3 ml of water at the center point above the specimen, when the water completely penetrates the specimen after 60 s, use a hacksaw to cut the specimen along the center line position of the water penetration on the surface of the specimen, use a scale to measure the depth of water penetration inside the specimen, used to characterize the permeability resistance of the specimen, the test results are shown in Table 1.

TABLE 1
Performance test results of the benchmark and example specimens

| | Dry | Penetration | Thermal |
|---|---|---|---|
| Example of | density | depth of | conductivity |
| implementation | (kg/m³) | moisture/mm | (W/m · K) |
| Benchmark | 480.7 | 28 | 0.1725 |
| group | | | |
| Example 1 | 394.8 | 21 | 0.1558 |
| Example 2 | 387 | 24 | 0.1310 |
| Example 3 | 441.3 | 13 | 0.1626 |

The test data of 1#, 2# and 3# foam concrete prepared by the comprehensive benchmark group and Examples 1˜3, where the lowest dry density of Example 2 foam concrete is 387 kg/m³, the lowest thermal conductivity is 0.1310 (W/m·K), and the best impermeability performance of Example 3 is 13 mm, with excellent impermeability and thermal insulation ability, which has certain application value in the field of building exterior wall insulation panels The solid diagrams of the impermeability testing of the specimens are shown in FIGS. 6 and 7, respectively. From the graphs, it can be verified that the incorporation of nano-silica can enhance the impermeability performance of foam concrete.

The technical solution of the present invention is not limited to the limitation of the above specific embodiment, and any technical deformation made according to the technical solution of the present invention falls within the scope of protection of the present invention.

1. A high impermeability and low thermal conductivity inorganic lightweight foam concrete, characterized in that it comprises the following raw materials in the following mass percentages:
1260-1540 parts of ordinary silicate cement;
20-60 parts of nano-silica;
460-740 parts of fly ash;
360-440 parts of aggregates;
9-11 parts of redispersible latex powder;
7.2-8.8 parts of polypropylene fiber;
27-33 parts of quicklime;
500 parts of fluorine-free foam;
900-1100 parts of water;
said fluorine-free foam is compounded from silicon surfactant, hydrocarbon surfactant, nanosilica, ammonium polyphosphate, urea and water, said silicon surfactant, hydrocarbon surfactant, nanosilica, ammonium polyphosphate and urea ratios are 0.06%-0.1%, 0.06%-0.1%, 0.06%-0.1%, 0.1%-0.2%, 0.3%-0.4%, the remainder being water;
Said silicone surfactant is LS-99, and said hydrocarbon surfactant is anionic sodium dodecyl sulfate SDS.

2. The high impermeability low thermal conductivity inorganic lightweight foam concrete according to claim 1, characterized in that said nano-silica has an average particle size of 20-30 nm and a SiO₂ content of 99.99%.

3. The high impermeability low thermal conductivity inorganic lightweight foam concrete according to claim 1, characterized in that said aggregate is Zhengzhou origin river sand with a fineness modulus of 2.4-2.8 and a particle size of 0.4-0.5 mm.

4. The high impermeability low thermal conductivity inorganic lightweight foam concrete according to claim 1, characterized in that said re-dispersible latex powder has a pH value of 7, an average particle size of 70-80 μm and a solid content of 98%.

5. The high impermeability low thermal conductivity inorganic lightweight foam concrete according to claim 1, characterized in that said polypropylene fibers have a phase volume diameter of 0.04-0.05 mm, a length of 10-12 mm and an apparent density of 0.90 g/cm³.

6. A method for preparing high impermeability low thermal conductivity inorganic lightweight foam concrete as claimed in claim 1, characterized in that it comprises the following steps:
In the first step, ordinary silicate cement weighed by an electronic balance is poured into a mixing bucket, and nano-silica particles are mixed into the silicate cement, and dry mixing is carried out using a mixer so that the silicate cement and the nano-silica particles are fully mixed in advance;
In the second step, the weighed fly ash, aggregate, polypropylene fiber, re-dispersible latex powder and quick-setting agent were sequentially added to the silicate cement and nano-silicon dioxide that were sufficiently mixed in the first step, and at the same time, the original solution of fluorine-free foams was mixed with the appropriate amount of water, and the fluorine-free foams required for the experiments were prepared through the drive of the air compressor to prepare the standby;
In the third step, the weighed water is added to the mixing bucket after mixing in the second step, and the mixer is used to mix thoroughly to obtain a cement-based slurry with reasonable fluidity and homogeneity;
In the fourth step, the foam prepared in the second step is mixed into the cement slurry mixed in the third step, and the mixer is used to mix thoroughly so that the foam is fully and uniformly dispersed in the cement slurry;
In the fifth step, the cement-based slurry mixed well in the fourth step is poured into the triplex steel test mold and pre-cured for 1-2 d and demolded after curing for 28 d to obtain foam concrete with high impermeability and low thermal conductivity.
